(19) United States
(12) Patent Application Publication
(10) Pub. No.: US 2007/0002698 A1
(43) Pub. Date: Jan. 4, 2007

(54) Recorder, recording method, player, and playback method

(75) Inventors: Masayoshi Nishitani, Kanagawa-ken (JP); Toshio Kuroiwa, Kanagawa-ken (JP); Seiji Higurashi, Tokyo (JP)

Correspondence Address: NATH & ASSOCIATES PLLC, 112 South West Street, Alexandria, VA, 22314, US

(73) Assignee: Victor Company of Japan, Limited, Yokohama-shi (JP)

(21) Appl. No.: 11/475,968

(22) Filed: Jun. 28, 2006

(30) Foreign Application Priority Data
Jun. 29, 2005 (JP) P2005-189385

(51) Int. Cl. G11B 21/08

(52) U.S. Cl. 369/30.07

(57) ABSTRACT

Additional information including three types of information is recorded in an additional information recording area provided for each recording block. The additional information includes first identification information for identifying a file that includes a recording block; either next-recording-block recording position information specifying a next recording block that is a recording block configuring the same file and following the recording block or terminal information indicating that the recording block is the terminal recording block of the recording blocks that configure the same file; and second identification information indicating whether the recording block is the first recording block of the recording blocks configuring the same file.

### BACKGROUND OF THE INVENTION

1. Field of the Invention

The present invention relates to a recorder, a recording method, a player, and a playback method applied to a system where content and information, such as images and sounds, are recorded as a file to, and played back or deleted from, a recording medium.

2. Description of the Related Art

One of recording media, which are developed fast recently, is an optical recording medium to which signals are recorded, or from which signals are played back or erased, using optical means. An optical recording medium is used primarily for recording and saving computer data and for playing back content such as movies and music.

To perform the operations and functions described above on an optical recording medium, the operation function is divided into three layers: physical layer, logical (file system) layer, and application layer.

The physical layer defines the physical part of an optical recording medium such as the medium shape, the structure of a sector that is the minimum recording unit, and the modulation method. They are defined as the physical specifications.

The logical layer provides the definitions for recognizing data, which is physically recorded on an optical recording medium, as a file. The logical layer determines the data (volume) space and the data management structure on a file basis and provides them to the application layer in the form of a file.

At the logical (file system) layer, the usage method of an optical recording medium is defined to allow a recorder or a player, including a computer, to process data, recorded on an optical recording medium, as a file. This usage method is called the logical standard.

At the application layer, the data structure for using content, such as videos and audios, and application, such as programs, is defined as the application standard on a file basis.

On an optical recording medium, data is recorded and played back in units of recording blocks called sectors. A sector has address information that is read by a recorder or a player to search for a sector to or from which data is recorded or played back.

When data is recorded onto an optical recording medium, the minimum writing unit is a sector as described above and a collection of data is a collection of sectors scattered in the recording area on the optical recording medium.

In this case, data recorded on the optical recording medium includes only the contents of the data, and the attribute information on the data such as the data type and the data size is not known. For this reason, the recorder or the player cannot recognize which scattered sectors constitute a collection of data and, therefore, cannot process the data as a file.

To solve this problem, the file system in the logical layer described above is provided as an intermediary that enables the recorder or the player to process sectors on an optical recording medium, on which data is recorded, as a file.

The file system determines the structure of a data (volume) space, which is the whole recording area of an optical recording medium, and the structure of a file to manage the recording area, the files, and the directory. As shown in FIG. 1, the file system itself is recorded on the recording area of an optical recording medium as file system data.

To play back file data, the player first searches for file system data recorded in the recording area on an optical recording medium and, from the file system data, reads the file structure information on the file data to be played back.

The file structure information indicates the attribute information such as the file data type and size as well as the addresses of the sectors in which the file data is recorded. When the sectors are scattered around in the recording area on the medium, the player reads the sector addresses and the information on the sequence of sectors in which the sectors are to be read to allow continuous data to be played back even if the sectors of the data are scattered.

For example, when three sectors are scattered as shown in FIG. 1, the sectors are read in order of sector 1, sector 2, and sector 3 based on the sector addresses and the sequence indicated by the file structure information.

The problem is that, when the file system data recorded on a recording medium such as an optical recording medium cannot be read, the position and attribute information on file data recorded on the medium cannot be obtained and, as a result, the file cannot be read.

### SUMMARY OF THE INVENTION

It is an object of the present invention to provide a recorder, a recording method, a player, and a playback method that can read a file even if the file system data defined in the file system cannot be read.

To achieve the above object, there is provided a recorder for recording file system data and a file onto a recording medium, the file system data defined by a file system for managing data as the file, the recorder comprising: an additional information generation unit that generates additional information corresponding to each recording block, the recording block being a recording unit of file data of the file on the recording medium, the additional information having three types of information comprising: first identification information that identifies the file that includes the recording block; either next recording block recording position information that specifies a next recording block that is a recording block configuring the same file and following the recording block or terminal information that indicates that the recording block is a terminal recording block of recording blocks that configure the same file; and a second identification information that indicates whether the recording block is a first recording block of recording blocks configuring the same file; and a recording unit that records the additional information in an additional information recording area provided in the recording block and records the file data of the file in an area other than the additional information recording area of the recording block.

The recorder according to the present invention records file system data, defined by the file system, in a predetermined area on a recording medium and, at the same time, records additional information, which identifies a recording block configuring a file, in each recording block on the recording medium. Therefore, the recorder according to the present invention can provide a recording medium that allows a file to be read based on the additional information even if the file system data cannot be read.

To achieve the above object, there is provided a recording method for recording file system data and a file onto a recording medium, the file system data defined by a file system for managing data as the file, the recording method comprising: an additional information generation step of generating additional information corresponding to each recording block, the recording block being a recording unit of file data of the file on the recording medium, the additional information having three types of information comprising: first identification information for identifying the file that includes the recording block, the first identification information being file attribute information or a file name defined in the file system; either next recording block recording position information that specifies a next recording block that is a recording block configuring the same file and following the recording block or terminal information that indicates that the recording block is a terminal recording block of recording blocks that configure the same file; and second identification information that indicates whether the recording block is a first recording block of recording blocks configuring the same file; a first recording step of recording the additional information in an additional information recording area provided in the recording block; and a second recording step of recording the file data of the file in an area other than the additional information recording area of the recording block.

The recording method according to the present invention records file system data, defined by the file system, in a predetermined area on a recording medium and, at the same time, records additional information, which identifies a recording block configuring a file, in each recording block on the recording medium. Therefore, the recording method according to the present invention can provide a recording medium that allows a file to be read based on the additional information even if the file system data cannot be read.

In addition, because file attribute information or a file name defined by the file system is used as the first identification information for identifying a file in the additional information, the recording method according to the present invention can cooperate with the file system to easily manage the file using the additional information.

To achieve the above object, there is provided a player for playing back file system data, defined by a file system for managing data as a file, from a recording medium on which the file system data and the file are recorded and, based on the played back file system data, for reading the file from each recording block that is a recording unit of file data of the file on the recording medium, the player comprising: a reading unit that reads additional information on the recording block from an additional information recording area provided in the recording block if the file system data cannot be played back; a generation unit that generates new file management data based on the additional information that is read; and a control unit that controls the reading unit to read the file from the recording medium based on the new file management data, wherein the reading unit reads three types of information as the additional information comprising: first identification information that identifies the file that includes the recording block; either next recording block recording position information that specifies a next recording block that is a recording block configuring the same file and following the recording block or terminal information that indicates that the recording block is a terminal recording block of recording blocks that configure the same file; and second identification information that indicates whether the recording block is a first recording block of recording blocks configuring the same file, and wherein the generation unit performs a first detection operation in which the additional information on the first recording block of the recording blocks configuring the same file is detected based on the second identification information in the additional information that is read and, in addition, recording position information on the first recording block is detected, performs a second detection operation in which, based on recording position information included in the detected additional information, additional information on a next recording block, which is a recording block configuring the same file and following the first recording block that includes the detected additional information, is obtained and whether the additional information on the next recording block includes the recording position information or the terminal information is detected, and, if it is found as a result of the second detection operation that the additional information includes the recording position information, repeats an operation to obtain additional information on a next following recording block and the second detection operation for the obtained additional information but, if it is found as a result of the second detection operation that the additional information includes the terminal information, generates the new file management data based on the additional information on the same file that has been collected until the additional information including the terminal information is obtained and on the recording position information on the first recording block of the same file, the new file management data composed of the recording position information on the recording blocks configuring the file specified by the first identification information included in the additional information on the first recording block and the first identification information, the recording position information on the recording blocks arranged in order of occurrence.

Even if file system data cannot be read, the player according to the present invention can read additional information from a recording block on a recording medium to generate new file management data for reading the file.

Especially, in this embodiment, the file can be read quickly based on the new file management data.

To achieve the above object, there is provided a player for playing back file system data, defined by a file system for managing data as a file, from a recording medium on which the file system data and the file are recorded and, based on the played back file system data, for reading the file from each recording block that is a recording unit of file data of the file on the recording medium, the player comprising: a reading unit that reads additional information on the recording block from an additional information recording area provided in the recording block if the file system data cannot be played back; a generation unit that generates new file management data based on the additional information that is read; and a control unit that controls the reading unit to read the file from the recording medium based on the new file management data, wherein the reading unit reads three types of information as the additional information comprising: first identification information that identifies the file that includes the recording block; either next recording block recording position information that specifies a next recording block that is a recording block configuring the same file and following the recording block or terminal information that indicates that the recording block is a terminal recording block of recording blocks that configure the same file; and second identification information that indicates whether the recording block is a first recording block of recording blocks configuring the same file, wherein the generation unit performs a first detection operation, in which the additional information on the first recording block of the recording blocks configuring the same file is detected based on the second identification information in the additional information that is read and, in addition, recording position information on the first recording block is detected, and generates the new file management data composed of the first identification information included in the detected additional information and recording position information on the first recording block that includes the detected additional information, and wherein the control unit causes the reading unit to read the additional information and the file data from the first recording block of the recording blocks configuring the same file based on the new file management data corresponding to specified first identification information, causes the reading unit to read the additional information and the file data from a next recording block, which is a recording block configuring the same file and following the first recording block, based on the recording position information included in the additional information that is read, performs a second detection operation in which whether the additional information read from the next recording block includes the recording position information or the terminal information is detected, and, if it is found as a result of the second detection operation that the additional information includes the recording position information, repeats an operation to cause the reading unit to read the additional information and the file data from a next following recording block and the second detection operation for the obtained additional information but, if it is found as a result of the second detection operation that the additional information includes the terminal information, terminates the read operation of the reading unit to read the file corresponding to the specified first identifier for causing the reading unit, thereby reading the file corresponding to the specified first identification information.

Even if file system data cannot be read, the player according to the present invention can read additional information from a recording block on a recording medium to generate new file management data for reading the file.

Especially, in this embodiment, the new file management data can be generated quickly.

To achieve the above object, there is provided a playback method for playing back file system data, defined by a file system for managing data as a file, from a recording medium on which the file system data and the file are recorded and, based on the played back file system data, for reading the file from each recording block that is a recording unit of file data of the file on the recording medium, the playback method comprising: a first reading step of reading additional information on the recording block from an additional information recording area provided in the recording block if the file system data cannot be played back; a generation step of generating new file management data based on the additional information that is read; and a second reading step of reading the file from the recording medium based on the new file management data, wherein the first reading step reads three types of information as the additional information comprising: first identification information that identifies the file that includes the recording block, the first identification information being file attribute information or a file name defined in the file system; either next recording block recording position information that specifies a next recording block that is a recording block configuring the same file and following the recording block or terminal information that indicates that the recording block is a terminal recording block of recording blocks that configure the same file; and second identification information that indicates whether the recording block is a first recording block of recording blocks configuring the same file, and wherein the generation step performs a first detection operation in which the additional information on the first recording block of the recording blocks configuring the same file is detected based on the second identification information in the additional information that is read and, in addition, recording position information on the first recording block is detected, performs a second detection operation in which, based on recording position information included in the detected additional information, additional information on a next recording block, which is a recording block configuring the same file and following the first recording block that includes the detected additional information, is obtained and whether the additional information on the next recording block includes the recording position information or the terminal information is detected, and, if it is found as a result of the second detection operation that the additional information includes the recording position information, repeats an operation to obtain additional information on a next following recording block and the second detection operation for the obtained additional information but, if it is found as a result of the second detection operation that the additional information includes the terminal information, generates the new file management data based on the additional information on the same file that has been collected until the additional information including the terminal information is obtained and on the recording position information on the first recording block of the same file, the new file management data composed of the recording position information on the recording blocks configuring the file specified by the first identification information included in the additional information on the first recording block and the first identification information, the recording position information on the recording blocks arranged in order of occurrence.

Even if file system data cannot be read, the playback method according to the present invention can read additional information from a recording block on a recording medium to generate new file management data for reading the file.

In addition, because identification information using file attribute information or a file name defined by the file system is used as the first identification information for identifying a file in the additional information, the playback method according to the present invention can cooperate with the file system to easily manage the file using the additional information.

Especially, in this embodiment, the file can be read quickly based on the new file management data.

To achieve the above object, there is provided a method for playing back file system data, defined by a file system for managing data as a file, from a recording medium on which the file system data and the file are recorded and, based on the played back file system data, for reading the file from each recording block that is a recording unit of file data of the file on the recording medium, the playback method comprising: a first reading step of reading additional information on the recording block from an additional information recording area provided in the recording block if the file system data cannot be played back; a generation step of generating new file management data based on the additional information that is read; and a second reading step of reading the file from the recording medium based on the new file management data, wherein the first reading step reads three types of information as the additional information comprising: first identification information that identifies the file that includes the recording block, the first identification information being file attribute information or a file name defined in the file system; either next recording block recording position information that specifies a next recording block that is a recording block configuring the same file and following the recording block or terminal information that indicates that the recording block is a terminal recording block of recording blocks that configure the same file; and second identification information that indicates whether the recording block is a first recording block of recording blocks configuring the same file, wherein the generation step performs a first detection operation, in which the additional information on the first recording block of the recording blocks configuring the same file is detected based on the second identification information in the additional information that is read and, in addition, recording position information on the first recording block is detected, and generates the new file management data composed of the first identification information included in the detected additional information and recording position information on the first recording block that includes the detected additional information, and wherein the second reading step reads the additional information and the file data from the first recording block of the recording blocks configuring the same file based on the new file management data corresponding to specified first identification information, reads the additional information and the file data from a next recording block, which is a recording block configuring the same file and following the first recording block, based on the recording position information included in the additional information that is read, performs a second detection operation in which whether the additional information read from the next recording block includes the recording position information or the terminal information is detected, and, if it is found as a result of the second detection operation that the additional information includes the recording position information, repeats an operation to read the additional information and the file data from a next following recording block and the second detection operation for the obtained additional information but, if it is found as a result of the second detection operation that the additional information includes the terminal information, terminates the read operation of the file corresponding to the specified first identifier, thereby reading the file corresponding to the specified first identification information.

Even if file system data cannot be read, the playback method according to the present invention can read additional information from a recording block on a recording medium to generate new file management data for reading the file.

In addition, because identification information using file attribute information or a file name defined by the file system is used as the first identification information for identifying a file in the additional information, the playback method according to the present invention can cooperate with the file system to easily manage the file using the additional information.

Especially, in this embodiment, the new file management data can be generated quickly.

The nature, principle and utility of the invention will become more apparent from the following detailed description when read in conjunction with the accompanying drawings.

### BRIEF DESCRIPTION OF THE DRAWINGS

In the accompanying drawings:

FIG. 1 is a diagram showing an example of the layout on a conventional optical recording medium;

FIG. 2 is a diagram showing the structure of a sector in one embodiment;

FIG. 3 is a diagram showing an example of the sector configuration on a recording-type Blu-ray disc;

FIG. 4 is a diagram showing an example of the representation of absolute physical addresses of sectors in one embodiment;

FIG. 5 is a diagram showing an example of the representation of relative physical addresses of sectors in one embodiment;

FIG. 6 is a diagram showing an additional-information recording area in one embodiment;

FIG. 7 is a diagram showing additional information for each sector in one embodiment;

FIG. 8 is a diagram showing an example of a recorder/player to which one embodiment is applied;

FIG. 9 is a diagram showing an example of file management data generated by the recorder/player to which one embodiment is applied; and

FIG. 10 is a diagram showing an example of file management data generated by the recorder/player to which one embodiment is applied.

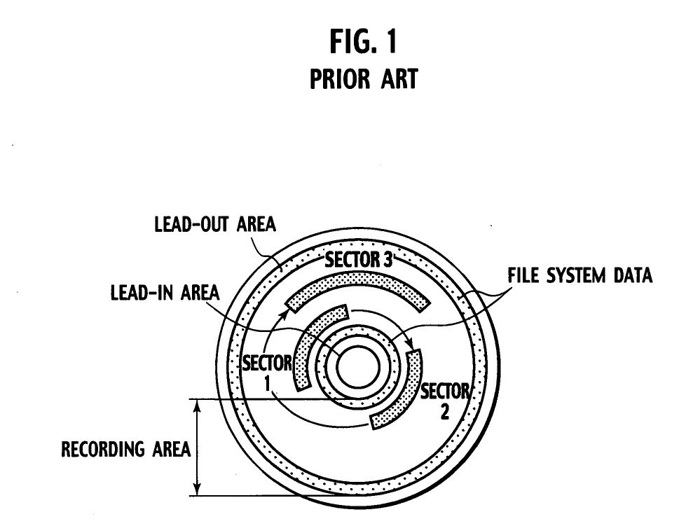

### DESCRIPTION OF THE PREFERRED EMBODIMENTS

An embodiment of a recorder, a recording method, a player, and a playback method according to the present invention will be described below with reference to the drawings. First, the following describes additional information that is recorded.

The following describes an example of recording in units of sectors that are recording blocks used for a commercially available, recording-type Blu-ray (hereinafter abbreviated to BD-RE) disc.

When data is recorded on a BD-RE disc, main data is written in units of sectors each containing 64 KB of main data, as shown in FIG. 3. The main data area contains a bit stream generated by multiplexing MPEG-2 coded images and sounds. This bit stream is a stream format called a transport stream (hereinafter abbreviated to TS) suitable for fixed-length packet transmission. The BD-RE standard defines a TS packet as a 192-byte, fixed-length packet. Because one sector contains 341 and ⅓ packets, some packets extend across the sector boundary as shown in FIG. 3 when data is processed in units of sectors. To solve this problem, the conventional method records and plays back three sectors at a time and, therefore, requires a memory in the device sufficient for recording and playback.

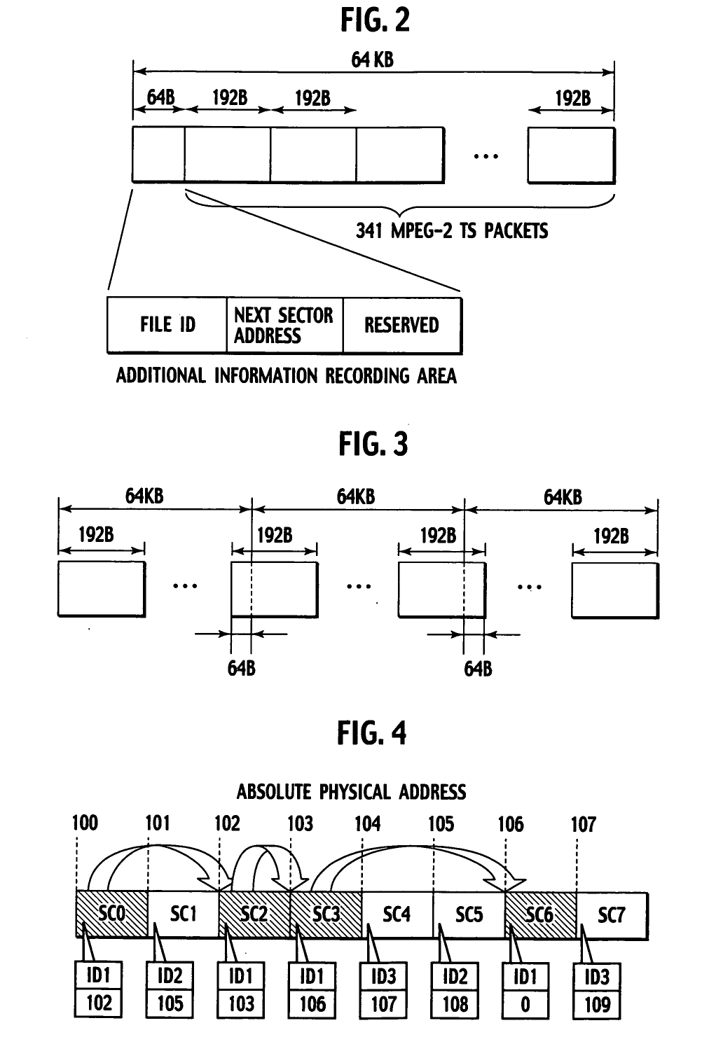

To reduce the memory amount that is the problem with the conventional method, additional information used in this embodiment is recorded in a sector, as shown in FIG. 2, to allow data to be recorded and played back, one sector at a time. That is, because one sector is composed of 341 and ⅓ packets as described previously in the description of a BD-RE disc, the area corresponding to a ⅓ packet, which is an odd part, is used as the additional-information recording area in which additional information used in this embodiment is recorded and the remaining packets are used for recording usual main data (file data).

In the additional-information recording area in which additional information is recorded, two types of information are recorded, one is the “File Identifier: File ID” of the file to which file data recorded in the packets of the sector belongs and the other is the “Next Recording Sector Position Information: Next Sector Address”. (The first identification information, which identifies the file including this sector, and the next-sector recording position information, which specifies the next sector following this sector to indicate that the next sector configures the same file, are recorded).

The file identifier varies among files so that to which file the file data, recorded in sectors, belongs can be identified. The file identifier is identification information uniquely representing the file such as the file recording start time information and the file name. Although dependent on the file system, file attribute information or a file name used for managing file recording and defined in the file system, if used for the file identifier, allows the file to be managed in cooperation with the file system.

The next recording sector position information, which indicates the position of the next sector configuring the same file, contains the absolute physical address indicating the position of the next sector from the start of the disc. The sector, in which the last file data of the file is recorded as file data, does not have to show the physical address of the next sector; therefore, the next recording sector position information contains 0 to indicate that the sector contains the last data of the file (0 is recorded as the “Terminal Information” to indicate that the sector is the last sector of the sectors configuring the same time).

Additionally, “reserved” in the additional information recording area shown in FIG. 2 and FIG. 6 for which an explanation will be given later is a bit space for reserving an area for future use and thus may be used as so-called staffing bits, terminal identifier bits indicating that the sector is the terminal sector of the file, and so on.

FIG. 4 is a diagram showing an example of File Identifiers and their Next Recording Sector Position Information recorded in the sectors on an optical disc. The numerals in the top of FIG. 4 represent the absolute physical addresses of the start positions of the sectors from the start of the disc. The additional-information recording area, which is at the start of each sector and in which additional information is recorded, contains IDi (i=1, 2, 3, . . . ) as the File Identifier and the absolute physical address of the next sector, in which data is recorded next, as the Next Recording Sector Position Information (For easy understanding, the additional information is shown in the balloon in FIG. 4).

To recognize the data configuration of file 1 not via the file system data, the additional information is read from the additional-information recording areas of the sectors sequentially from the start of the disc to search for a sector in which the additional information containing File Identifier ID1, which indicates file 1, is recorded at the start. Next, from the Next Recording Sector Position Information in the additional information containing File Identifier ID1, the absolute physical address of the next sector is read as a sector configuring the same file and control is passed to the next sector. Thereafter, the search is continued similarly until the sector is found where the Next Recording Sector Position Information in the additional information recorded in the additional-information recording area is 0 (The value of 0 is the Terminal Information indicating that the sector is the last sector of the same file). The data configuration of file 1 is recognized in this manner

In the example shown in FIG. 4, the search is started at sector SC0 at the absolute physical address 100 where the additional information includes file identifier ID1 that indicates file 1. Following the absolute physical addresses, each indicating the Next Recording Sector Position Information, allows sectors to be searched for in order of SC0, SC2, SC3, and SC6. The search indicates that file 1 includes data composed of sectors SC0, SC2, SC3, and SC6.

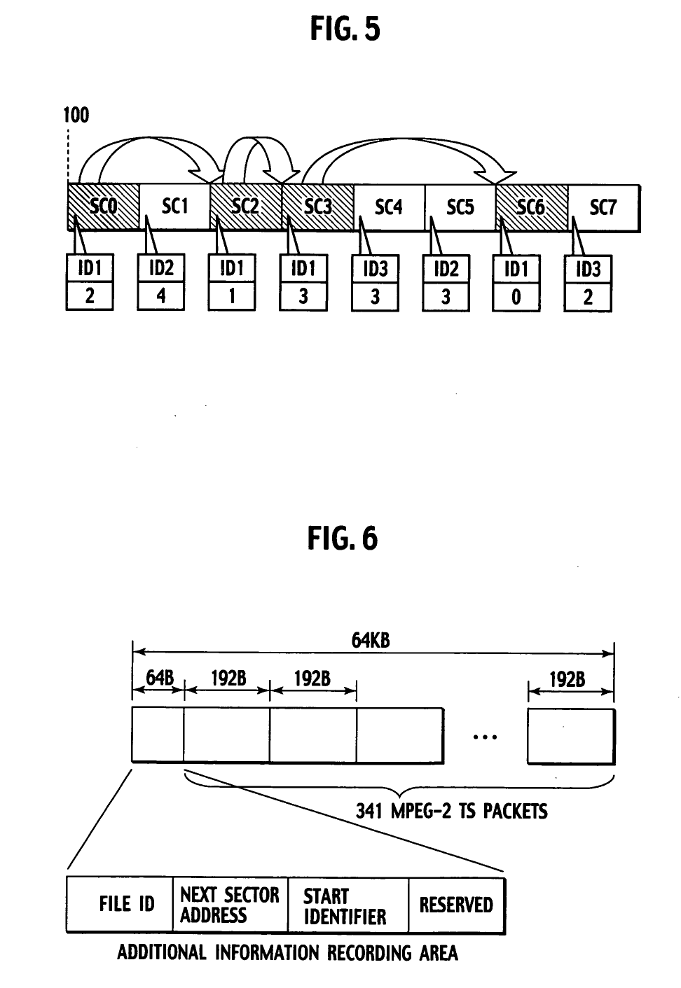

Although the absolute physical address of a sector is used for the Next Recording Sector Position Information, it is also possible to use the relative physical address. FIG. 5 shows an example. FIG. 5 is a diagram showing the relative physical addresses generated from the Next Recording Sector Position Information in the additional information in the sectors in FIG. 4. In this figure, the data configuration of file 1 can be recognized in the same way as in FIG. 4.

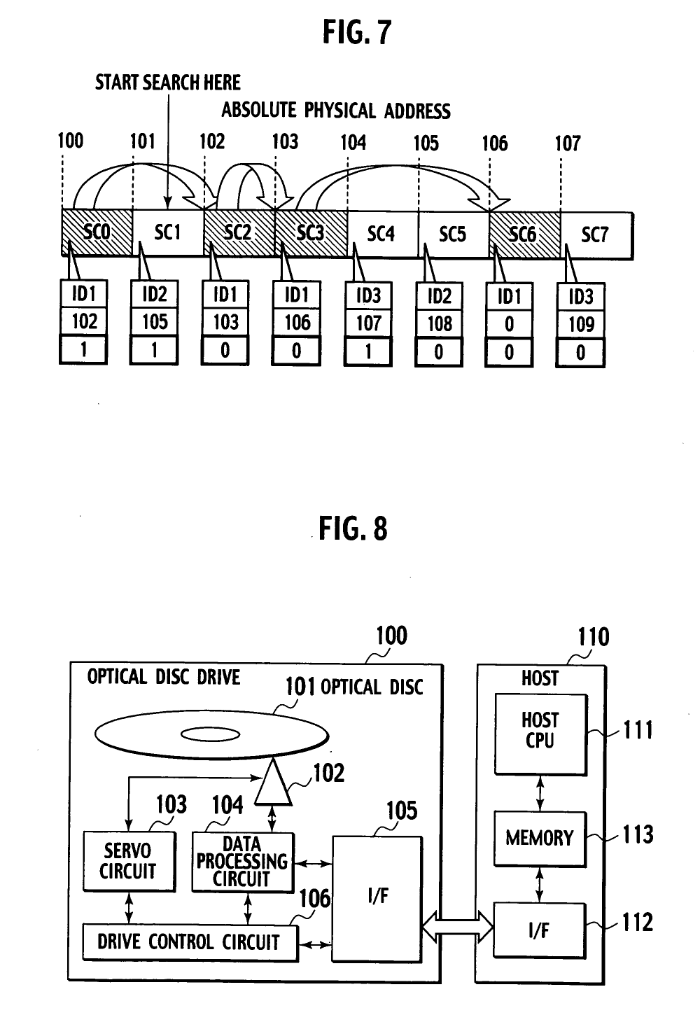

Consider that the recognition of the data configuration of file 1 is started, not from the start of a disc, but from any position on the disc, for example, from a position between the absolute physical addresses 101 and 102, as shown in FIG. 7. In this case, when the search is made for the sectors whose additional-information recording area includes additional information indicating File Identifier ID1 that indicates file 1, the sectors are returned in order of SC2, SC3, and SC6. The returned result indicates that the configuration of file 1 is incorrectly recognized because the start sector SC0 of file 1 is not recognized. To solve this problem, the Start Identifier that indicates whether or not the sector is the start sector of the file is recorded in the additional-information recording area of each sector as shown in FIG. 6 (The second identification information is recorded to indicate whether the sector is the start sector of the sectors configuring the same file).

In FIG. 7, the numeral in the bottom box in the balloon corresponding to the additional-information recording area of each sector represents the Start Identifier. If it is 1, the sector is the start sector; if it is 0, the sector is not the start sector.

In the example shown in FIG. 7, the search through file 1 is started in sector SC2 and the Start Identifier is checked when the search is started. If the identifier is 1, the usual search is made; if the identifier is 0, the search position is moved to a position preceding the current search position and the search is made for a sector whose additional-information recording area includes the additional information that indicates File Identifier ID1.

Although an odd-length (non-integer length) area generated by dividing a sector by a fixed-length packet is used as the additional-information recording area in the example above, it is also possible to use the first packet in a sector as the additional-information recording area if the result of division is an integer.

In summary, the additional information include:
File Identifier: File ID. This is the identifier of the file to which the file data recorded in the packets of the sector belongs, that is, the first identification information identifying the file that includes this sector.
Start Identifier. This is the identifier that indicates whether the sector is the first sector of the file, that is, the second identification information indicating whether the sector is the first sector of the sectors configuring the same file.
Next Recording Sector Position Information: Next Sector Address. This information is the next sector recording position information specifying the next sector that follows this sector and that is one of the sectors configuring the same file. When this sector is the last sector of the sectors configuring the same file, the information becomes Terminal Information.

FIG. 8 is a diagram showing an example of an optical disc recorder/player that is a recorder/player in one embodiment of the present invention for recording or playing back data to or from an optical disc. The optical disc recorder/player comprises an optical disc drive 100 and a host 110.

The optical disc drive 100 comprises an optical pickup 102 necessary for recording and playing back content such as images and audios and information to or from an optical disc 101, a servo circuit 103, a data processing circuit 104, an interface (I/F) 105, and a drive control circuit (controller) 106.

The host 110 comprises a host CPU 111 that performs the internal processing of the host, an interface (I/F) 112 that sends and receives data and control signals to and from the optical disc drive 100, and a memory 113 in which the absolute physical address of the first sector of the sectors configuring a file and other information are recorded.

When the file data (real data) of content and information supplied from the host 110 is recorded onto the optical disc 101, the host CPU 111 reads the file system data from the optical disc 101 if such data is already recorded thereon and detects the sector layout of the recording area. The host CPU 111 sends to the memory 113 the total number of sectors required for recording the file data (real data) in the recording area and the absolute physical address that is the recording start position of each sector. In addition, to manage the recording file data (real data) as a file, the host CPU 111 sends the identification information, which distinguishes the file data from other file data (real data), to the memory 113.

In the memory 113, the file data (real data) received from the host CPU 111 is recorded in the layout of a sector shown in FIG. 6 and, at the same time, the identification information and the recording start position, which are already received, are recorded in the additional-information recording area at the start of the sector. At this time, the following are recorded in the additional-information recording area provided at the start of the sector: File Identifier that is the identification information indicating the file to which the file data (real data) recorded in the sector belongs, the Next Recording Sector Position Information that indicates the recording start position, and the Start Identifier that indicates whether the sector is the first sector of the file.

The File Identifier varies among files so that the fact that the file data, recorded in divisions, belongs to the same file can be identified. For example, the file identifier is identification information uniquely representing the file such as the file recording start time information and the file name. To allow the file to be managed in cooperation with the file system, the file attribute information recorded as file system data or the file name may also be recorded as the file identifier recorded in the sector.

In the Next Recording Sector Position Information, the absolute physical address indicating the position of the next sector from the start of the disc is recorded. This absolute physical address indicates the position information on the next recording sector that is one of the sectors configuring the same file. The Start Identifier is a marker used to find the first sector of the file when the file search is made.

When the sector is the last sector of the same file, 0 is recorded in the Next Recording Sector Position Information as the Terminal Information.

The host CPU 111 sequentially outputs the sectors, in each of which the file data (real data) and the additional information are arranged by the processing described above, from the memory 113 to the interface 112. The host CPU 111 terminates the sector output operation when it outputs the last sector of the same file.

Although the absolute physical address is used for the sector position information in the above example, it is also possible to use the absolute physical address from the start of the disc only for the position information on the first sector of a file, and the relative physical address from the current sector to the next sector for the position information on the subsequent sectors.

File system data defined by the file system is also generated and output as in the conventional method. That is, file system data is generated in the memory 113 in the same way as in the conventional system using the identification information, the total number of sectors, and the sector recording start positions that are output from the host CPU 111 separately from the file data (real data). The file system data is output to the interface 112 in the same way as the real data sectors, and is recorded by the optical disc drive 100 onto the optical disc 101 separately from the file data (real data) in the same way as in the conventional system.

The interface 112 outputs the sequentially received sectors to the interface 105 of the optical disc drive 100.

The optical disc drive 100 receives, via the interface 105, the data to be recorded, performs error correction encoding and modulation via the data processing circuit 104, and drives the optical pickup 102 to write the data onto the optical disc 101.

This sequence of operations causes additional information to be recorded in the additional-information recording area in a sector on the optical disc 101, and the file data (real data) to be recorded in the area in the sector other than the additional-information recording area.

Usually, to play back content or information from the optical disc 101, the optical disc drive 100 detects the file system data on the corresponding file from the file system, recorded on the optical disc 101, to access the sectors in which desired file data is recorded. First, if the file system can be read, a laser beam is focused from the optical pickup 102 to the optical disc 101 to access the file including file data (real data) specified by the host 110. Then, the drive control circuit 106 receives the instruction command from the host 110 via the interface 105 and controls the servo circuit 103 to move the optical pickup 102 to the file system area recorded on the optical disc 101.

Next, the optical disc drive 100 searches the file system data area for the file system data corresponding to the content or information to be played back and moves the optical pickup to the sector corresponding to the sector position information recorded in the file system data to read the pits. Then, the data processing circuit 104 performs modulation/demodulation and error correction decoding and sends the recorded data to the host 110 via the interface 105.

The host 110 receives recorded data via the interface 112 and accumulates the received data in the memory 113. The host CPU 111 sequentially receives the recorded data to play back the content or information.

As described above, the optical disc recorder/player can easily play back a file via the file system data. However, if the file system data on the optical disc 101 cannot be read, for example, when there is a scratch on the disc, the position information and attribute information on data recorded in the recording area on the optical disc 101 become unavailable for use and the data cannot be read.

By contrast, the optical disc recorder/player in this embodiment can identify the sectors configuring a file on the optical disc 101 and recognize the file even if the file system data cannot be recognized.

More specifically, data is read and searched for sequentially, one sector at a time, beginning at the start of the storage area on the optical disc 101 for analyzing the additional information read from the additional-information recording area provided at the start of each sector. If the Start Identifier in the additional information is 1 indicating that the sector is the first sector of a file, the File Identifier in the additional information in the sector and the absolute physical address of the sector are recorded in the memory 113.

Once the position of the first sector of a file is obtained, it is possible to obtain the sectors constituting the same file by following the addresses indicated by the Next Recording Sector Position Information in the additional information in the additional-information recording areas of the following sectors. When a sector is found whose Next Recording Sector Position Information in the additional information contains 0 (that is, Terminal Information), all sectors of the file can be recognized.

This sequence of processing, if performed to the end of the storage area of the optical disc 101, produces information on the sector configuration of the files recorded on the optical disc 101 and creates new file management data. Accessing this new file management data, generated by the host 110 and recorded in the memory 113, allows any file to be played back.

Also, when the search is started not from the first sector of the storage area of the optical disc 101 but from a storage area in any position on the optical disc 101, the processing is performed in the same way as when the search is started from the start of the storage area. That is, a sector is detected whose Start Identifier in the additional information in the additional-information recording area of the sector is 1 indicating that the sector is the first sector of the file, and the File Identifier stored in the additional information of the sector and the absolute physical address of the sector are recorded into the memory 113.

If the Start Identifier in the additional information of a sector from which the search is started is 0, it is possible to move the optical pickup 102 to the track immediately preceding the track, to which the sector belongs, for continuing the search for a sector whose Start Identifier in the additional information is 1.

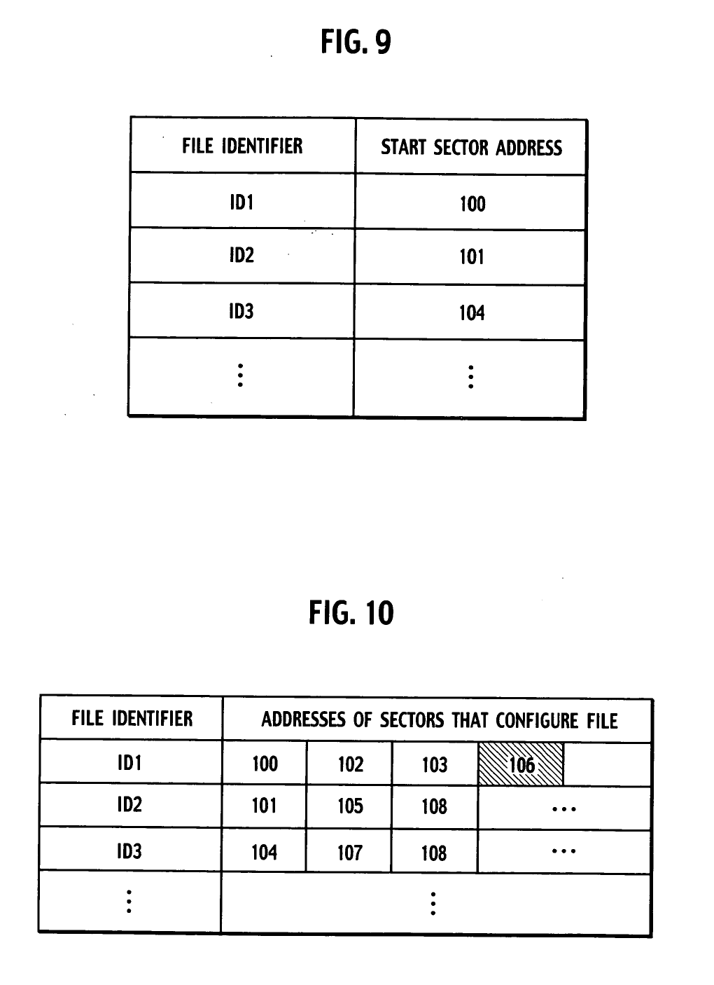

Based on the additional information detected in the sectors in this way, new file management data for recognizing the sectors and files, such as the one shown in FIG. 9, is built in the memory 113.

The data map in FIG. 9 is an example of file management data recorded in the memory 113. This data map is created by sequentially searching and checking the sector string in FIG. 7 for the additional information in the additional-information recording area of the sectors, beginning at the sector at absolute physical address 100.

The host 110 specifies a file to be played back, not from the file system data recorded on the optical disc 101, but from the new file management data map built in the memory 113. The following describes the playback of a file with file 1 as an example. When the user selects file 1 as a file to be played back via the host 110, the host 110 searches the data map, built in the memory 113, for the File Identifier ID1 of file 1.

A file may be selected, for example, by displaying the data map, built in the memory 113, as a list of files on the display of the host 110 in the GUI (Graphic User Interface) format to allow the user to select a file. The selection method in this embodiment is not limited to the one described above as long as the file list can be presented to the user.

Next, the host 110 sends the absolute physical address of the first sector, corresponding to the File Identifier ID1 of the selected file 1, from the memory 113 to the optical disc drive 100 via the interface 112. The optical disc drive 100 controls the servo circuit 103 via the drive control circuit 106 to move the optical pickup 102 to the received absolute physical address in the recording area on the optical disc 101. The optical disc drive 100 reads the sector at the received absolute physical address via the optical pickup 102, causes the data processing circuit 104 to perform modulation/demodulation processing and error correction decoding processing, and sends the recorded data (additional information and file data), which is read, to the host 110 via the interface 105.

The host 110 receives the recorded data (additional information and file data), which is read, via the interface 112 and accumulates it in the memory 113. The host CPU 111 sequentially receives the recorded data and plays back the content and the information.

At the same time, the host 110 extracts the absolute physical address of the next sector from the Next Recording Sector Position Information in the additional information. The host 110 sends this absolute physical address to the optical disc drive 100 again via the interface 112. Upon receiving this absolute physical address, the optical disc drive 100 reads the sector at the absolute physical address of the next sector. After that, the optical disc drive 100 sends the recorded data (additional information and file data), which is read, to the host 110.

The sequence of operations described above is repeated until a sector whose Next Recording Sector Position Information in the additional information is 0, that is, a sector having the Terminal Information as the additional information, is read and the recorded data is played back from that sector.

That is, the control unit (host 110) performs the second detection operation to detect which of the two types of information the additional information, read from the next recording block, has: one is recording position information (Next Recording Sector Position Information is not 0) and the other is terminal information (Next Recording Sector Position Information is 0). If it is found as a result of the second detection operation that the additional information has the recording position information, the control unit repeats the operation in which the reading unit (optical disc drive 100) reads the additional information and file information from the next recording block, followed by the second detection operation for the additional information that is read. If it is found as a result of the second detection operation that the additional information has the terminal information, the control unit terminates the operation of the reading unit (optical disc drive 100) to read the file corresponding to the specified first identification information (File Identifier ID1). The control unit performs the sequence of operation described above to cause the reading unit to read the file corresponding to the specified first identification information (File Identifier ID1).

FIG. 9 shows an example of new file management data in which pairs, each composed of a file identifier and the physical address of its first sector described in the first sector of the file, are recorded in the memory 113.

The following describes another example in which data is sequentially read and searched for, one sector at a time, beginning at the start of the storage area as in the example shown in FIG. 9 and the additional information read from the additional-information recording area provided at the start of each sector is analyzed. The absolute physical addresses of the sectors of a file, detected by the analysis, are recorded in the memory 113 as the file management data in which the file identifier is followed by the absolute physical addresses in order of their occurrence. FIG. 10 shows an example. The file management data shown in FIG. 10 also corresponds to the sector string shown in FIG. 7 to which the file management data in FIG. 9 corresponds.

The file management data shown in FIG. 10, composed of the absolute physical addresses of the sectors of a file arranged in order of occurrence, directly shows the file configuration. Thus, as compared with the file management data shown in FIG. 9, the file management data in FIG. 10 enables the host 110 to access a file quickly.

Conversely, the file management data shown in FIG. 9, simpler in the contents than that in the example shown in FIG. 10, enables the host 110 to generate file management data quickly.

The following describes how to generate the file management data shown in FIG. 10.

As in the example shown in FIG. 9, the host 110 causes the optical disc drive 100 to sequentially read and search for data, beginning at the start of the storage area of the optical disc 101, one sector at a time and analyzes the additional information, read from the additional-information recording area provided at the start of each sector, as follows.

Based on the Start Identifier (second identification information) in the additional information that is read, the host 110 detects the additional information on the first sector of the sectors (recording blocks) configuring the same file (detects the additional information whose Start Identifier is 1). At the same time the additional information is detected, the host 110 detects the recording position information (absolute physical address) of the first sector. This detection operation is called a first detection operation.

Based on the recording position information in the additional information detected as the additional information on the first sector, the host 110 identifies the additional information on the next sector, which follows the first sector, as a sector configuring the same file. Then, the host 110 performs a second detection operation in which a check is made whether the identified additional information on the next sector includes the Next Recording Sector Position Information that is not 0 or the Next Recording Sector Position Information that is 0 (a check is made which information is detected, recording position information or terminal information).

If it is found as a result of the second detection operation that the additional information includes the Next Recording Sector Position Information that is not 0 (includes recording position information), the host 110 repeats the operation for identifying the additional information on the next sector and the second detection operation for the identified additional information.

If it is found as a result of the second detection operation that the additional information includes the Next Recording Sector Position Information that is 0 (includes terminal information), the host 110 performs the following operation. That is, based on the additional information on the same file collected until the additional information including the terminal information is obtained and on the recording position information on the first recording block of the same file, the host 110 generates new file management data composed of the recording position information arranged in order of occurrence of the sectors, which configure the file specified by the File Identifier (first identification information) included in the additional information in the first recording block, and the File Identifier (first identification information).

In this way, the host 110 generates the file management data shown in FIG. 10. The file management data, composed of the absolute physical addresses of the sectors of a file arranged in order of occurrence, directly shows the file configuration.

The host 110 specifies a file to be played back, not from the file system data recorded on the optical disc 101, but from the new file management data built in the memory 113 and shown in FIG. 10. The following describes the playback of a file with file 1 as an example. When the user selects file 1 as a file to be played back via the host 110, the host 110 searches the file management data (data map), built in the memory 113 and shown in FIG. 10, for the File Identifier ID1 of file 1.

A file may be selected, for example, by displaying the file management data, built in the memory 113, as a list of files on the display of the host 110 in the GUI (Graphic User Interface) format to allow the user to select a file. The selection method in this embodiment is not limited to the one described above as long as the file list can be presented to the user.

Next, the host 110 sends the absolute physical address [100] of the first sector, corresponding to the File Identifier ID1 of the selected file 1, from the memory 113 to the optical disc drive 100 via the interface 112. The optical disc drive 100 controls the servo circuit 103 via the drive control circuit 106 to move the optical pickup 102 to the received absolute physical address in the recording area on the optical disc 101. The optical disc drive 100 reads the sector at the received absolute physical address via the optical pickup 102, causes the data processing circuit 104 to perform modulation/demodulation processing and error correction decoding processing, and sends the recorded data (additional information and file data), which is read, to the host 110 via the interface 105.

Similarly, the host 110 sequentially reads the subsequent absolute physical addresses [102], [103] and [106] from the file management data on the File Identifier ID1 recorded in the memory 113 and sends them to the optical disc drive 100. The optical disc drive 100 sequentially reads the recorded data (additional information and file data) from the sectors and sends the recorded data to the host 110.

The host 110 receives the recorded data (additional information and file data), which is read, via the interface 112, one sector at a time, and accumulates it in the memory 113. The host CPU 111 sequentially receives the recorded data and plays back the content and the information.

In this way, a file can be read from the optical disc 101 based on the new file management data shown in FIG. 10.

It should be understood that many modifications and adaptations of the invention will become apparent to those skilled in the art and it is intended to encompass such obvious modifications and changes in the scope of the claims appended hereto.

What is claimed is:

1. A recorder for recording file system data and a file onto a recording medium, said file system data defined for a file system for managing data as the file, said recorder comprising:
an additional information generation unit that generates additional information corresponding to each recording block, said recording block being a recording unit of file data of the file on the recording medium,
said additional information having three types of information comprising:
first identification information that identifies the file that includes said recording block;
either next recording block recording position information that specifies a next recording block that is a recording block configuring the same file and following said recording block or terminal information that indicates that said recording block is a terminal recording block of recording blocks that configure the same file; and
a second identification information that indicates whether said recording block is a first recording block of recording blocks configuring the same file; and
a recording unit that records the additional information in an additional information recording area provided in said recording block and records the file data of the file in an area other than the additional information recording area of said recording block.

2. A recording method for recording file system data and a file onto a recording medium, said file system data defined by a file system for managing data as the file, said recording method comprising:
an additional information generation step of generating additional information corresponding to each recording block, said recording block being a recording unit of file data of the file on the recording medium,
said additional information having three types of information comprising:
first identification information for identifying the file that includes said recording block, said first identification information being file attribute information or a file name defined in the file system;
either next recording block recording position information that specifies a next recording block that is a recording block configuring the same file and following said recording block or terminal information that indicates that said recording block is a terminal recording block of recording blocks that configure the same file; and
second identification information that indicates whether said recording block is a first recording block of recording blocks configuring the same file;
a first recording step of recording the additional information in an additional information recording area provided in said recording block; and
a second recording step of recording the file data of the file in an area other than the additional information recording area of said recording block.

3. A player for playing back file system data, defined by a file system for managing data as a file, from a recording medium on which the file system data and the file are recorded and, based on the played back file system data, for reading the file from each recording block that is a recording unit of file data of the file on the recording medium, said player comprising:
a reading unit that reads additional information on said recording block from an additional information recording area provided in said recording block if the file system data cannot be played back;
a generation unit that generates new file management data based on the additional information that is read; and
a control unit that controls said reading unit to read the file from the recording medium based on the new file management data,
wherein said reading unit reads three types of information as the additional information comprising:
first identification information that identifies the file that includes said recording block;
either next recording block recording position information that specifies a next recording block that is a recording block configuring the same file and following said recording block or terminal information that indicates that said recording block is a terminal recording block of recording blocks that configure the same file; and
second identification information that indicates whether said recording block is a first recording block of recording blocks configuring the same file, and
wherein said generation unit performs a first detection operation in which the additional information on the first recording block of the recording blocks configuring the same file is detected based on the second identification information in the additional information that is read and, in addition, recording position information on the first recording block is detected, performs a second detection operation in which, based on recording position information included in the detected additional information, additional information on a next recording block, which is a recording block configuring the same file and following the first recording block that includes the detected additional information, is obtained and whether the additional information on the next recording block includes the recording position information or the terminal information is detected, and, if it is found as a result of the second detection operation that the additional information includes the recording position information, repeats an operation to obtain additional information on a next following recording block and the second detection operation for the obtained additional information but, if it is found as a result of the second detection operation that the additional information includes the terminal information, generates the new file management data based on the additional information on the same file that has been collected until the additional information including the terminal information is obtained and on the recording position information on the first recording block of the same file, said new file management data composed of the recording position information on the recording blocks configuring the file specified by the first identification information included in the additional information on the first recording block and the first identification information, said recording position information on the recording blocks arranged in order of occurrence.

4. A player for playing back file system data, defined by a file system for managing data as a file, from a recording medium on which the file system data and the file are recorded and, based on the played back file system data, for reading the file from each recording block that is a recording unit of file data of the file on the recording medium, said player comprising:
a reading unit that reads additional information on said recording block from an additional information recording area provided in said recording block if the file system data cannot be played back;
a generation unit that generates new file management data based on the additional information that is read; and
a control unit that controls said reading unit to read the file from the recording medium based on the new file management data,
wherein said reading unit reads three types of information as the additional information comprising:
first identification information that identifies the file that includes said recording block;
either next recording block recording position information that specifies a next recording block that is a recording block configuring the same file and following said recording block or terminal information that indicates that said recording block is a terminal recording block of recording blocks that configure the same file; and
second identification information that indicates whether said recording block is a first recording block of recording blocks configuring the same file,
wherein said generation unit performs a first detection operation, in which the additional information on the first recording block of the recording blocks configuring the same file is detected based on the second identification information in the additional information that is read and, in addition, recording position information on the first recording block is detected, and generates the new file management data composed of the first identification information included in the detected additional information and recording position information on the first recording block that includes the detected additional information, and
wherein said control unit causes said reading unit to read the additional information and the file data from the first recording block of the recording blocks configuring the same file based on the new file management data corresponding to specified first identification information, causes said reading unit to read the additional information and the file data from a next recording block, which is a recording block configuring the same file and following the first recording block, based on the recording position information included in the additional information that is read, performs a second detection operation in which whether the additional information read from the next recording block includes the recording position information or the terminal information is detected, and, if it is found as a result of the second detection operation that the additional information includes the recording position information, repeats an operation to cause said reading unit to read the additional information and the file data from a next following recording block and the second detection operation for the obtained additional information but, if it is found as a result of the second detection operation that the additional information includes the terminal information, terminates the read operation of said reading unit to read the file corresponding to the specified first identifier for causing said reading unit, thereby reading the file corresponding to the specified first identification information.

5. A playback method for playing back file system data, defined by a file system for managing data as a file, from a recording medium on which the file system data and the file are recorded and, based on the played back file system data, for reading the file from each recording block that is a recording unit of file data of the file on the recording medium, said playback method comprising:
a first reading step of reading additional information on said recording block from an additional information recording area provided in said recording block if the file system data cannot be played back;
a generation step of generating new file management data based on the additional information that is read; and
a second reading step of reading the file from the recording medium based on the new file management data,
wherein said first reading step reads three types of information as the additional information comprising:
first identification information that identifies the file that includes said recording block, said first identification information being file attribute information or a file name defined in the file system;
either next recording block recording position information that specifies a next recording block that is a recording block configuring the same file and following said recording block or terminal information that indicates that said recording block is a terminal recording block of recording blocks that configure the same file; and
second identification information that indicates whether said recording block is a first recording block of recording blocks configuring the same file, and
wherein said generation step performs a first detection operation in which the additional information on the first recording block of the recording blocks configuring the same file is detected based on the second identification information in the additional information that is read and, in addition, recording position information on the first recording block is detected, performs a second detection operation in which, based on recording position information included in the detected additional information, additional information on a next recording block, which is a recording block configuring the same file and following the first recording block that includes the detected additional information, is obtained and whether the additional information on the next recording block includes the recording position information or the terminal information is detected, and, if it is found as a result of the second detection operation that the additional information includes the recording position information, repeats an operation to obtain additional information on a next following recording block and the second detection operation for the obtained additional information but, if it is found as a result of the second detection operation that the additional information includes the terminal information, generates the new file management data based on the additional information on the same file that has been collected until the additional information including the terminal information is obtained and on the recording position information on the first recording block of the same file, said new file management data composed of the recording position information on the recording blocks configuring the file specified by the first identification information included in the additional information on the first recording block and the first identification information, said recording position information on the recording blocks arranged in order of occurrence.

6. A method for playing back file system data, defined by a file system for managing data as a file, from a recording medium on which the file system data and the file are recorded and, based on the played back file system data, for reading the file from each recording block that is a recording unit of file data of the file on the recording medium, said playback method comprising:
a first reading step of reading additional information on said recording block from an additional information recording area provided in said recording block if the file system data cannot be played back;
a generation step of generating new file management data based on the additional information that is read; and
a second reading step of reading the file from the recording medium based on the new file management data,
wherein said first reading step reads three types of information as the additional information comprising:
first identification information that identifies the file that includes said recording block, said first identification information being file attribute information or a file name defined in the file system;
either next recording block recording position information that specifies a next recording block that is a recording block configuring the same file and following said recording block or terminal information that indicates that said recording block is a terminal recording block of recording blocks that configure the same file; and
second identification information that indicates whether said recording block is a first recording block of recording blocks configuring the same file,
wherein said generation step performs a first detection operation, in which the additional information on the first recording block of the recording blocks configuring the same file is detected based on the second identification information in the additional information that is read and, in addition, recording position information on the first recording block is detected, and generates the new file management data composed of the first identification information included in the detected additional information and recording position information on the first recording block that includes the detected additional information, and
wherein said second reading step reads the additional information and the file data from the first recording block of the recording blocks configuring the same file based on the new file management data corresponding to specified first identification information, reads the additional information and the file data from a next recording block, which is a recording block configuring the same file and following the first recording block, based on the recording position information included in the additional information that is read, performs a second detection operation in which whether the additional information read from the next recording block includes the recording position information or the terminal information is detected, and, if it is found as a result of the second detection operation that the additional information includes the recording position information, repeats an operation to read the additional information and the file data from a next following recording block and the second detection operation for the obtained additional information but, if it is found as a result of the second detection operation that the additional information includes the terminal information, terminates the read operation of the file corresponding to the specified first identifier, thereby reading the file corresponding to the specified first identification information.
